(19) United States
(12) Patent Application Publication
(10) Pub. No.: US 2026/0286819 A1
(43) Pub. Date: Sep. 24, 2026

(54) METHOD AND SYSTEMS FOR CYCLING A GEOTHERMAL WELL

(71) Applicant: Sage Geosystems Inc., Houston, TX (US)

(72) Inventors: Lev M. RING, Bellaire, TX (US); Cynthia D. TAFF, Kingwood, TX (US); Robert Lance COOK, Houston, TX (US)

(21) Appl. No.: 19/473,974

(22) PCT Filed: Apr. 19, 2024
(86) PCT No.: PCT/US2024/025441

§ 371 Date: Oct. 9, 2025

Related U.S. Application Data
(60) Provisional application No. 63/497,669, filed on Apr. 21, 2023.

(51) Int. Cl. E21B 43/26; E21B 43/14; E21B 43/24; F24T 10/00; F24T 10/20

(52) U.S. Cl. CPC E21B 43/26; E21B 43/14; E21B 43/24; F24T 10/20; F24T 2010/50

(57) ABSTRACT

A well is completed in a subterranean formation with first and second fractures. Geothermal fluid flows into the well via the first fracture while flow into the well via the second fracture is prevented. Geothermal fluid flows into the well via the second fracture while flow into the well via the first fracture Is prevented. Fluidic access in the well to the first and second fractures is closed off. Then the well is recompleted on the subterranean formation by creating third and fourth fractures in the subterranean formation. The first, second, third, and fourth fractures are discrete from each other. Geothermal fluid flows into the well via the third fracture while flow into the well via the first, second, and fourth fractures is prevented. Geothermal fluid flows into the well via the fourth fracture while flow Into the well via the first, second, and third fractures is prevented.

### CROSS-REFERENCE TO RELATED APPLICATIONS

This application is an International Patent Application under the Patent Cooperation Treaty and claims priority to and the benefit of U.S. Provisional Patent Application Ser. No. 63/497,669 filed Apr. 21, 2023 and titled Method and Systems for Cycling a Geothermal Well, the disclosure of which is incorporated herein in its entirety by this reference.

### BACKGROUND

### Field

Embodiments of the present disclosure generally relate to the production of geothermal fluids from a subterranean formation.

### Description of the Related Art

Geothermal energy is a type of renewable energy generated within the earth. A geothermal fluid (such as water, steam, brine, a refrigerant, or a hydrocarbon) is heated in a subterranean geological formation by the earth's natural internal temperature. The heated geothermal fluid is produced to the earth's surface, where the heat of the geothermal fluid is used to perform useful work, such as heating buildings or generating electricity. The now-cooled geothermal fluid is reinjected into the subterranean formation, reheated by the subterranean formation, then produced again to the earth's surface to perform useful work.

In some power systems, the geothermal fluid is flowed through a turbine, which drives a generator to generate electricity. In some power systems, the heat from geothermal fluid is used to provide power for a binary cycle power plant. A heat exchanger transfers heat from the geothermal fluid to a working fluid of the binary cycle power plant. In an example, operation of the binary cycle power plant is based on the Brayton Cycle, in which the heated working fluid passes through a turbine, which drives a generator. In another example, operation of the binary cycle power plant is based on the Organic Rankine Cycle, in which the heated working fluid passes through an expander, which drives a generator.

Exemplary working fluids include hydrocarbons and refrigerants that have boiling points lower than water. The working fluids are selected according to one or more criteria such as the temperature of the feed of geothermal fluid to the heat exchanger, and the ambient temperature at the binary cycle power plant. However, during the working life of a geothermal resource, the temperature of the geothermal fluid that is produced from the subterranean formation can change. In a phenomenon known as thermal decline, the temperature of geothermal fluid being produced from the subterranean formation decreases over time.

Thermal decline can necessitate the changing of the equipment of a geothermal power system, such as the binary cycle power plant. Equipment such as the turbine/expander is expensive, and changing this equipment can be costly and time-consuming. Thermal decline can necessitate also the changing of the working fluid, or the geothermal fluid itself, which can adversely affect the performance of a geothermal power system.

Typically, geothermal fluids are produced from subterranean formations via fractures in the subterranean formations that are fluidically coupled to wells. The rate of thermal decline of a geothermal resource is related to the exposure of the geothermal fluids to the subterranean formation in the fractures. The larger the surface area of fractures, the smaller the rate of thermal decline. Consequently, some geothermal systems utilize many wells and/or many fractures coupled to individual wells. A fracturing operation is cumbersome and expensive, involving many pumps conveying large quantities of fracturing fluids at high rates and pressures.

Controlling fluid flows into and out of a large number of fractures coupled to a single well can be problematic. For example, to mitigate the effect of thermal decline it is often necessary to direct fluid flow into or out of certain fractures, while preventing fluid flow into or out of other fractures. Typically, such selectivity is accomplished using valves, such as sliding sleeves, in a well. However, operating such valves requires either downhole motors and electronics, or frequent well interventions to mechanically switch valves to open or closed, which adds cost and complexity to the well and to the operations. Furthermore, under geothermal operating conditions, the valves can deteriorate, leak, or can become jammed in an open or closed position, which adversely affects the capability to control fluid flow.

There is a need for improved systems and methods that mitigate the effects of thermal decline without incurring the large up-front costs and operational complexities of current systems.

### SUMMARY

The present disclosure generally relates to the production of geothermal fluids from a subterranean formation. In one implementation, a method includes producing geothermal fluid from a subterranean formation into a first zone in a well via a first fracture while production of geothermal fluid from the subterranean formation into a second zone in the well is prevented. The method further includes ceasing production of geothermal fluid into the first zone and producing geothermal fluid from the subterranean formation into the second zone via a second fracture while production of geothermal fluid into the first zone is prevented. The method further includes closing fluidic access in the well to the first and second zones after producing geothermal fluid into the first and second zones, and opening fluidic access between the subterranean formation and a third zone in the well and between the subterranean formation and a fourth zone in the well while fluidic access in the well to the first and second zones is closed. The opening includes creating a third fracture in the subterranean formation proximal to the third zone, and creating a fourth fracture in the subterranean formation proximal to the fourth zone. The method further includes producing geothermal fluid from the subterranean formation into the third zone via the third fracture while production of geothermal fluid into the first, second, and fourth zones is shut off. The method further includes shutting off production of geothermal fluid into the third zone, and producing geothermal fluid from the subterranean formation into the fourth zone via the fourth fracture while production into the first, second, and third zones in the well is shut off.

In another implementation, a method includes flowing geothermal fluid into a well from a subterranean formation. The flowing includes alternately flowing the geothermal fluid through a first tubing string in the well and through a first annulus between the first tubing string and a casing string. The geothermal fluid flows from the subterranean formation via a first fracture into a first zone of the well, and into the first tubing string. The geothermal fluid flows from the subterranean formation via a second fracture into a second zone of the well, and into the first annulus. The method further includes closing fluidic access in the well to the first and second zones, and opening fluidic access between the subterranean formation and a third zone in the well and between the subterranean formation and a fourth zone in the well while fluidic access in the well to the first and second zones is closed. The opening includes creating a third fracture in the subterranean formation proximal to the third zone, and creating a fourth fracture in the subterranean formation proximal to the fourth zone. The method further includes recommencing flowing geothermal fluid into the well from the subterranean formation. The flowing includes alternately flowing the geothermal fluid through a second tubing string in the well and through a second annulus between the second tubing string and the casing string. The geothermal fluid flows from the subterranean formation via the third fracture into the third zone of the well, and into the second tubing string. The geothermal fluid flows from the subterranean formation via the fourth fracture into the fourth zone of the well, and into the second annulus.

In another implementation, a method includes flowing geothermal fluid from a subterranean formation into a first zone of a well via a first fracture in the subterranean formation, and flowing the geothermal fluid produced into the first zone to surface. The method further includes shutting off of geothermal fluid into the first zone, flowing geothermal fluid from the subterranean formation into a second zone of the well via a second fracture in the subterranean formation while flow of geothermal fluid into the first zone is shut off, and flowing the geothermal fluid produced into the second zone to surface. The method further includes determining a decline in a temperature of the geothermal fluid flowing from the first fracture or from the second fracture. The method further includes closing fluidic access in the well to the first and second zones after determining the decline in the temperature of the geothermal fluid flowing from the first fracture or from the second fracture, and opening fluidic access between the subterranean formation and a third zone in the well and between the subterranean formation and a fourth zone in the well while fluidic access in the well to the first and second zones is closed. The opening includes creating a third fracture in the subterranean formation proximal to the third zone, and creating a fourth fracture in the subterranean formation proximal to the fourth zone. The method further includes flowing geothermal fluid from the subterranean formation into the third zone of the well via the third fracture in the subterranean formation while flow of geothermal fluid into the first, second, and fourth zones is shut off. The method further includes shutting off production of geothermal fluid into the third zone, and flowing geothermal fluid from the subterranean formation into the fourth zone of the well via the fourth fracture in the subterranean formation while flow of geothermal fluid into the first, second, and third zones in the well is shut off.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a geothermal power system.

FIG. 2 schematically illustrates a well that may be used with the geothermal power system of FIG. 1. The well is depicted during an exemplary operational phase.

FIG. 3 schematically illustrates another operational phase of the well of FIG. 2.

FIG. 4 schematically illustrates another operational phase of the well of FIG. 2.

FIG. 5 schematically illustrates another operational phase of the well of FIG. 2.

FIG. 6 schematically illustrates another operational phase of the well of FIG. 2.

FIG. 7 schematically illustrates another operational phase of the well of FIG. 2.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns the production of geothermal fluids from a subterranean formation.

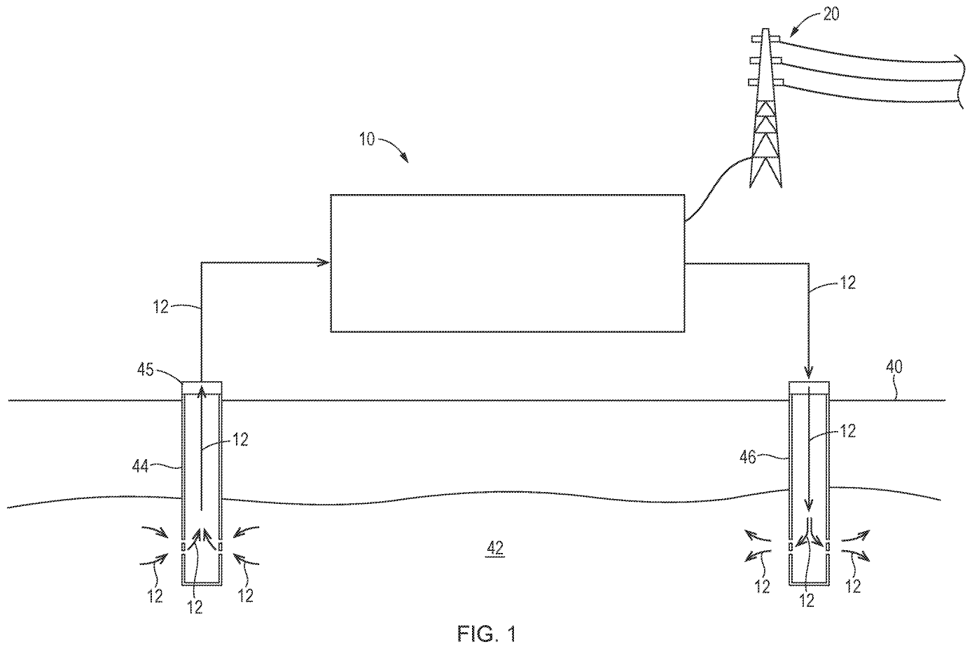

FIG. 1 schematically illustrates a geothermal power system 10. The geothermal power system 10 utilizes a geothermal fluid (represented by arrows 12). The geothermal fluid 12 may include any fluid (such as water, steam, brine, a refrigerant, a supercritical fluid, carbon dioxide, ammonia, an organic compound (e.g., a hydrocarbon, a fluorocarbon, etc.), or any combination thereof) that is injected into, or produced out of, a subterranean formation 42. In some embodiments, the subterranean formation 42 is a geothermal subterranean formation.

The geothermal fluid 12 may be heated, or may be maintained at an elevated temperature, by the subterranean formation 42. In an example, the temperature of the geothermal fluid 12 is at or about 150 degrees C or higher, such as 175 degrees C or higher, 200 degrees C or higher, 250 degrees C or higher, or 300 degrees C or higher. The geothermal fluid 12 is maintained at an elevated pressure in the subterranean formation 42. In an example, the pressure of the geothermal fluid 12 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 12 is geopressured. In an example, the geothermal fluid 12 may be a geopressured-geothermal fluid.

The geothermal fluid 12 flows from the subterranean formation 42 into a first well 44, and flows up the first well 44 to a wellhead 45 at the earth's surface 40. The geothermal fluid 102 flows from the wellhead 45 to the geothermal power system 10.

In some embodiments, the geothermal power system 10 includes one or more turbines that drive corresponding generators to generate electricity. In some embodiments, the geothermal power system 10 includes a binary cycle power plant that generates electricity. The generated electricity is routed to an electricity distribution network 20, such as a power grid.

As illustrated, in some embodiments, the geothermal fluid 12 returns from the geothermal power system 10, and is injected back into the subterranean formation 42 via a second well 46. The geothermal fluid 12 is heated by the subterranean formation 42, and then is produced back to the geothermal power system 10, and the cycle is repeated. In some embodiments, the geothermal fluid 12 is produced from the subterranean formation via the first well 44, and is injected back into the subterranean formation via the first well 44, and the cycle is repeated.

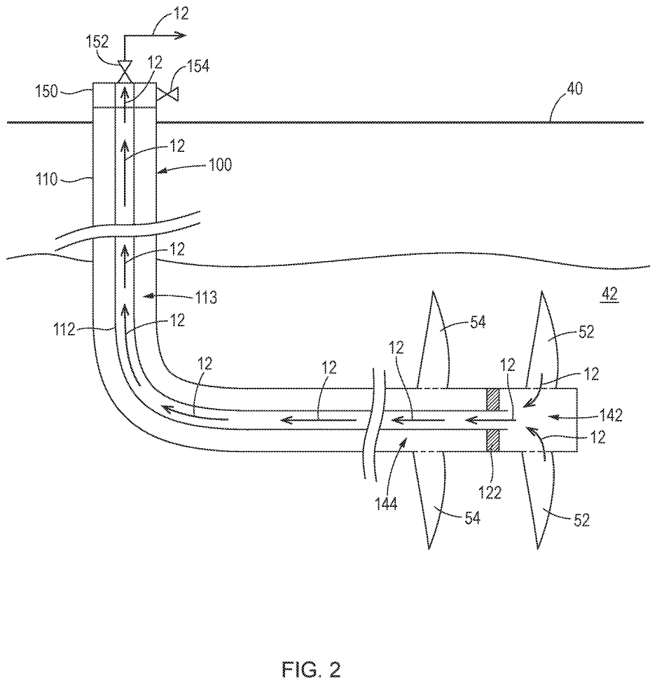

FIG. 2 schematically illustrates a well 100 that may be used as the first well 44 in conjunction with the geothermal power system 10. The well 100 includes a casing string 110 that extends from a wellhead 150 at the earth's surface 40 into the subterranean formation 42. The wellhead 150 may be used as the wellhead 45. In some embodiments, the casing string includes one or more liners suspended from a casing. A tubing string 112 disposed within the casing string 110 extends from the wellhead 150 to a packer 122 within the casing string 110 in the subterranean formation 42. The packer 122 separates a first zone 142 of the well 100 from a second zone 144 of the well 100.

A first fracture 52 in the subterranean formation 42 fluidically couples the subterranean formation 42 with the first zone 142 of the well 100. The first fracture 52 includes one or more individual fractures that are fluidically coupled within the subterranean formation 42. A second fracture 54 in the subterranean formation 42 fluidically couples the subterranean formation 42 with the second zone 144 of the well 100. The second fracture 54 includes one or more individual fractures that are fluidically coupled within the subterranean formation 42. In some embodiments, the first fracture 52 and the second fracture 54 are distinct or separate from each other. In an example, the first fracture 52 is not fluidically coupled with the second fracture 54 within the subterranean formation 42.

FIG. 2 schematically illustrates the well 100 during an exemplary operational phase. Geothermal fluid 12 is produced from the subterranean formation 42 into the well 100 via the first fracture 52, and enters the well at the first zone 142. The geothermal fluid 12 produced into the first zone 142 flows up through the tubing string 112 to the wellhead 150. Valve 152 at the wellhead 150 controls fluid flow into, and out of, the tubing string 112. In the illustrated operation, valve 152 is open, and the geothermal fluid 12 flows to the geothermal power system 10, such as through a flowline.

Flow of geothermal fluid 12 from the subterranean formation 42 via the second fracture 54 into the well 100 at the second zone 144 is prevented. The second zone 144 of the well 100 is fluidically coupled with the wellhead 150 via the annulus 113 between the tubing string 112 and the casing string 110. Valve 154 at the wellhead 150 controls fluid flow into, and out of, the annulus 113. In the illustrated operation, valve 154 is closed, and geothermal fluid 12 in the annulus 113 does not flow out of the wellhead 150. A back-pressure is maintained on the geothermal fluid 12 within the second fracture 54, and geothermal fluid 12 in the subterranean formation 42 does not flow into the second zone 144 of the well 100.

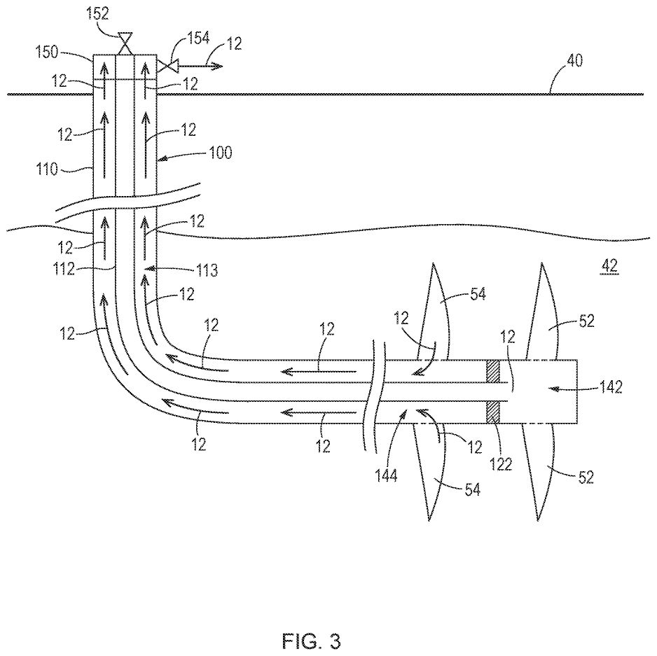

FIG. 3 schematically illustrates another operational phase of the well 100. Valve 152 is closed, ceasing flow of geothermal fluid 12 through the tubing string 112. A back-pressure is created on the geothermal fluid 12 within the first fracture 52, and geothermal fluid 12 in the subterranean formation 42 ceases to flow into the first zone 142 of the well 100. Valve 154 is opened, relieving the back-pressure on the geothermal fluid 12 in the annulus 113. Geothermal fluid 12 is produced from the subterranean formation 42 into the well 100 via the second fracture 54, and enters the well at the second zone 144. The geothermal fluid 12 produced into the second zone 144 flows up through the annulus 113 to the wellhead 150. The open valve 154 permits the geothermal fluid 12 in the annulus 113 to flow to the geothermal power system 10, such as through a flowline.

In some embodiments, the operations depicted in FIGS. 2 and 3 are repeated in an alternating sequence. In an example, valve 154 is closed and valve 152 is opened. The flow of geothermal fluid 12 into the first zone 142 of the well 100 and through the tubing string 112 is commenced, and is maintained until a trigger condition occurs. The trigger condition may include a pressure of the geothermal fluid 12 at the first zone 142 or at the wellhead 150 declining towards, or approaching, or reaching, a threshold value. In some embodiments, the threshold value is related to a minimum pressure required to maintain the fracture 52 in a open condition. The trigger condition may include a temperature of the geothermal fluid 12 at the first zone 142 or at the wellhead 150 declining towards, or approaching, or reaching, a threshold value. In some embodiments, the threshold value is related to a minimum temperature required to operate the geothermal power system 10 at a desired efficiency or to produce a desired amount of electricity.

When the trigger condition occurs, flow of the geothermal fluid 12 from the subterranean formation 42 into the first zone 142 of the well 100 is ceased by closing the valve 152. Flow of geothermal fluid 12 from the subterranean formation 42 into the second zone 144 of the well 100 is commenced by opening the valve 154. The flow of geothermal fluid 12 into the second zone 144 of the well 100 and through the annulus 113 is maintained until a corresponding trigger condition occurs (such as described above). Then valve 154 is closed, valve 152 is opened, and the sequence is repeated.

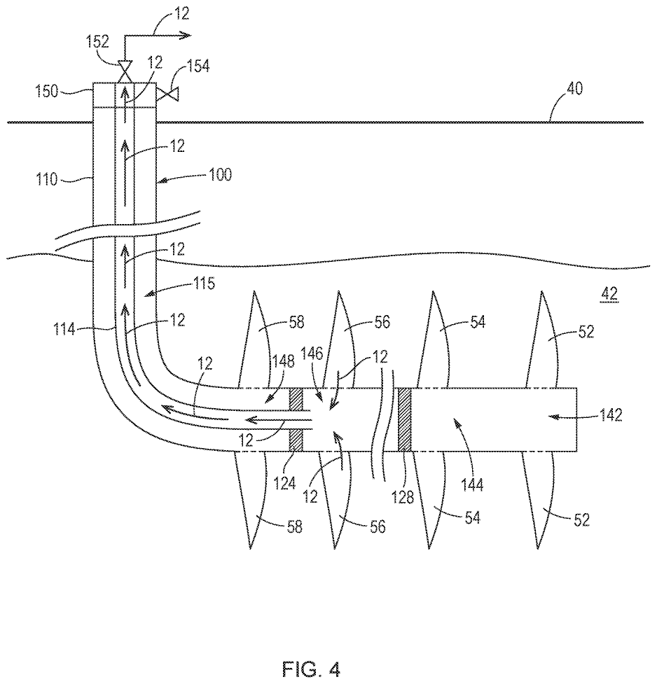

FIG. 4 schematically illustrates another operational phase of the well 100. FIG. 4 depicts the well 100 after being reconfigured to produce geothermal fluid 12 from the subterranean formation 42 via a third fracture 56 and a fourth fracture 58. In some embodiments, the reconfiguration is performed in response to an operational condition with respect to the geothermal fluid 12 produced from the subterranean formation 42 via the first fracture 52 and/or the second fracture 54. In some embodiments, the operational condition is thermal decline. For example, a temperature of the geothermal fluid 12 at the first zone 142 or at the wellhead 150 declines towards, or approaches, or reaches, a threshold value even at (or shortly after) commencing flow of the geothermal fluid 12 into the first zone 142. Additionally, or alternatively, a temperature of the geothermal fluid 12 at the second zone 144 or at the wellhead 150 declines towards, or approaches, or reaches, a threshold value even at (or shortly after) commencing flow of the geothermal fluid 12 into the second zone 144.

The reconfiguring includes closing fluidic access in the well 100 to the first zone 142 and the second zone 144. Closing fluidic access in the well 100 to the first zone 142 and the second zone 144 also closes fluidic access in the well 100 to the first fracture 52 and the second fracture 54. The tubing string 112 is removed from the well 100. In some embodiments, the packer 122 is removed from the well 100. Then a barrier 128, such as a bridge plug, is installed in the well 100 between the wellhead 150 and the first zone 142 and the second zone 144. The barrier 128 prevents geothermal fluid 12 in the first zone 142 and the second zone 144 from flowing in the well 100 to the wellhead 150. The pressures of the geothermal fluid 12 in the first fracture 52, the second fracture 54, the first zone 142, and the second zone 144 equalize, and so geothermal fluid 12 is hindered from flowing into the first zone 142 and the second zone 144. In some embodiments, the barrier 128 prevents fluid at the wellhead 150 from flowing in the well 100 to the first zone 142 or to the second zone 144.

The reconfiguring includes also the opening of fluidic access between the subterranean formation 42 and a third zone 146 in the well 100 and between the subterranean formation 42 and a fourth zone 148 in the well 100 while fluidic access in the well 100 to the first zone 142 and to the second zone 144 is closed. The reconfiguring includes creating the third fracture 56 in the subterranean formation 42 proximal to the third zone 146, and creating the fourth fracture 58 in the subterranean formation 42 proximal to the fourth zone 148. In some embodiments, creating the third fracture 56 and the fourth fracture 58 includes pumping a fracturing fluid into the well 100 at the wellhead 150. The fracturing fluid travels through the well 100, then out of the well 100 at the third zone 146 and at the fourth zone 148 and into the subterranean formation 42.

The reconfiguring further includes installing a second tubing string 114 in the well 100 after installing the barrier 128. The second tubing string 114 extends from the wellhead 150 to a packer 124 within the casing string 110 in the subterranean formation 42. The packer 124 separates the third zone 146 of the well 100 from the fourth zone 148 of the well 100.

The third fracture 56 in the subterranean formation 42 fluidically couples the subterranean formation 42 with the third zone 146 of the well 100. The third fracture 56 includes one or more individual fractures that are fluidically coupled within the subterranean formation 42. The fourth fracture 58 in the subterranean formation 42 fluidically couples the subterranean formation 42 with the fourth zone 148 of the well 100. The fourth fracture 58 includes one or more individual fractures that are fluidically coupled within the subterranean formation 42. In some embodiments, the third fracture 56 and the fourth fracture 58 are distinct or separate from each other. In an example, the third fracture 56 is not fluidically coupled with the fourth fracture 58 within the subterranean formation 42. In some embodiments, the first fracture 52, the second fracture 54, the third fracture 56, and the fourth fracture 58 are distinct or separate from each other. In an example, the first fracture 52, the second fracture 54, the third fracture 56, and the fourth fracture 58 are not fluidically coupled with any of each other within the subterranean formation 42.

FIG. 4 schematically illustrates the well 100 during an exemplary operational phase. Geothermal fluid 12 is produced from the subterranean formation 42 into the well 100 via the third fracture 56, and enters the well at the third zone 146. The geothermal fluid 12 produced into the third zone 146 flows up through the second tubing string 114 to the wellhead 150. Valve 152 at the wellhead 150 controls fluid flow into, and out of, the second tubing string 114. In the illustrated operation, valve 152 is open, and the geothermal fluid 12 flows to the geothermal power system 10, such as through a flowline.

Flow of geothermal fluid 12 from the subterranean formation 42 via the fourth fracture 58 into the well 100 at the fourth zone 148 is prevented. The fourth zone 148 of the well 100 is fluidically coupled with the wellhead 150 via the annulus 115 between the second tubing string 114 and the casing string 110. Valve 154 at the wellhead 150 controls fluid flow into, and out of, the annulus 115. In the illustrated operation, valve 154 is closed, and geothermal fluid 12 in the annulus 115 does not flow out of the wellhead 150. A back-pressure is maintained on the geothermal fluid 12 within the fourth fracture 58, and geothermal fluid 12 in the subterranean formation 42 does not flow into the fourth zone 148 of the well 100.

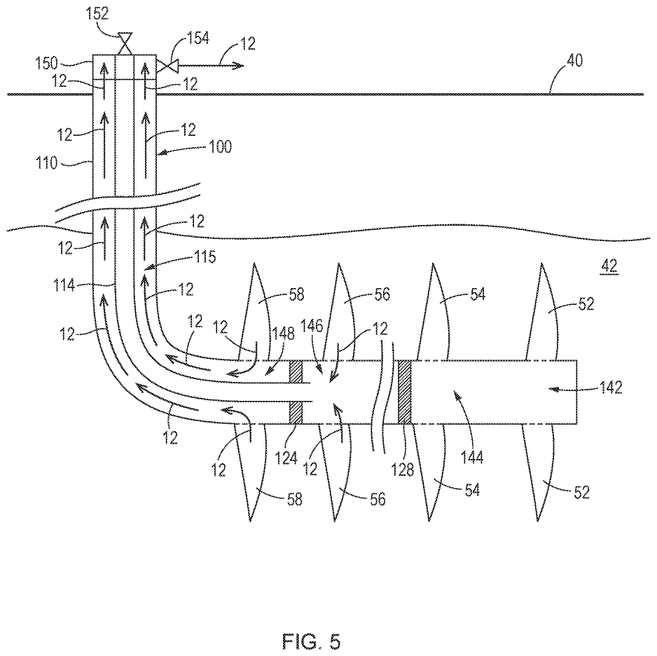

FIG. 5 schematically illustrates another operational phase of the well 100. Valve 152 is closed, ceasing flow of geothermal fluid 12 through the second tubing string 114. A back-pressure is created on the geothermal fluid 12 within the third fracture 56, and geothermal fluid 12 in the subterranean formation 42 ceases to flow into the third zone 146 of the well 100. Valve 154 is opened, relieving the back-pressure on the geothermal fluid 12 in the annulus 115. Geothermal fluid 12 is produced from the subterranean formation 42 into the well 100 via the fourth fracture 58, and enters the well at the fourth zone 148. The geothermal fluid 12 produced into the fourth zone 148 flows up through the annulus 115 to the wellhead 150. The open valve 154 permits the geothermal fluid 12 in the annulus 115 to flow to the geothermal power system 10, such as through a flowline.

In some embodiments, the operations depicted in FIGS. 4 and 5 are repeated in an alternating sequence. In an example, valve 154 is closed and valve 152 is opened. The flow of geothermal fluid 12 into the third zone 146 of the well 100 and through the second tubing string 114 is commenced, and is maintained until a trigger condition occurs. The trigger condition may include a pressure of the geothermal fluid 12 at the third zone 146 or at the wellhead 150 declining towards, or approaching, or reaching, a threshold value. In some embodiments, the threshold value is related to a minimum pressure required to maintain the fracture 56 in a open condition. The trigger condition may include a temperature of the geothermal fluid 12 at the third zone 146 or at the wellhead 150 declining towards, or approaching, or reaching, a threshold value. In some embodiments, the threshold value is related to a minimum temperature required to operate the geothermal power system 10 at a desired efficiency or to produce a desired amount of electricity.

When the trigger condition occurs, flow of the geothermal fluid 12 from the subterranean formation 42 into the third zone 146 of the well 100 is ceased by closing the valve 152. Flow of geothermal fluid 12 from the subterranean formation 42 into the fourth zone 148 of the well 100 is commenced by opening the valve 154. The flow of geothermal fluid 12 into the fourth zone 148 of the well 100 and through the annulus 115 is maintained until a corresponding trigger condition occurs (such as described above). Then valve 154 is closed, valve 152 is opened, and the sequence is repeated.

In some embodiments, the well 100 is reconfigured to produce geothermal fluid 12 from the subterranean formation 42 via additional fractures (not shown). In some embodiments, the reconfiguration is performed in response to an operational condition with respect to the geothermal fluid 12 produced from the subterranean formation 42 via the third fracture 56 and/or the fourth fracture 58. In some embodiments, the operational condition is thermal decline, such as described above. In some embodiments, the reconfiguring of the well 100 is similar to the reconfiguring described above, and includes removing the second tubing string 114 from the well 100, closing fluidic access in the well to the third zone 146 and the fourth zone 148 of the well 100 (which closes fluidic access in the well to the third fracture 56 and the fourth fracture 58), opening fluidic access between the subterranean formation 42 and additional zones of the well 100 (such as by creating fractures in the subterranean formation 42 proximal to the additional zones, as described above), and installing a new tubing string and packer (such as described above).

In some embodiments, in response to thermal decline of geothermal fluid produced from the subterranean formation 42 via the third fracture 56 and/or the fourth fracture 58, the well 100 is reconfigured to reopen fluidic access in the well to the first zone 142 and to the second zone 144. Such reconfiguring of the well 100 facilitates recommencing production of geothermal fluid 12 from the subterranean formation 42 via the first fracture 52 and the second fracture 54. It is contemplated that geothermal fluid 12 in the subterranean formation 42 proximal to the first fracture 52 and the second fracture 54 may be dormant while production of geothermal fluid 12 from the subterranean formation 42 is ongoing via the third fracture 56 and the fourth fracture 58. In some embodiments, such a period of dormancy may allow the thermal decline in the subterranean formation 42 proximal to the first fracture 52 and the second fracture 54 may be halted, or even reversed.

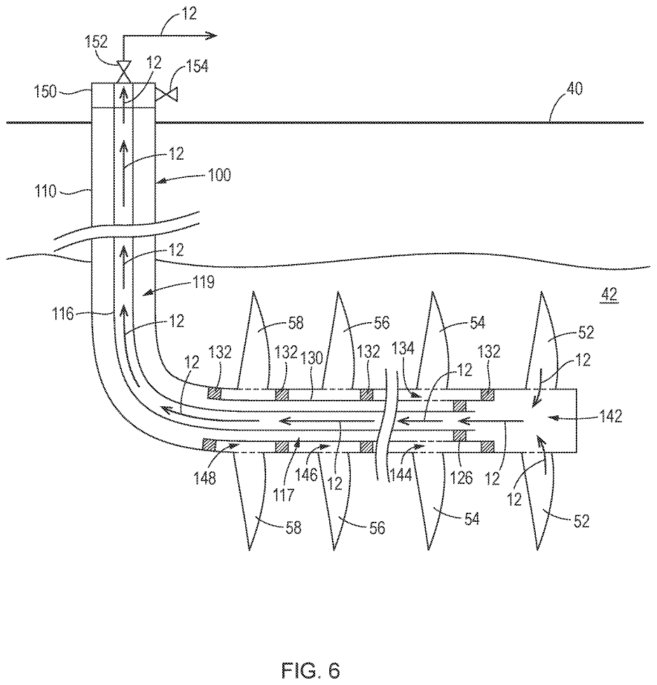

FIG. 6 schematically illustrates another operational phase of the well 100. FIG. 6 depicts the well 100 after being reconfigured to recommence production of geothermal fluid 12 from the subterranean formation 42 via the first fracture 52 and the second fracture 54.

The reconfiguring includes closing fluidic access in the well 100 to the third zone 146 and the fourth zone 148. Closing fluidic access in the well 100 to the third zone 146 and the fourth zone 148 also closes fluidic access in the well 100 to the third fracture 56 and the fourth fracture 58. The second tubing string 114 and the packer 124 are removed from the well 100. The barrier 128 is removed from the well 100. Then a patch 130 (such as a scab liner, an expandable liner, or a casing patch) is installed in the well 100 against the casing string 110 at the fourth zone 148 and the third zone 146. As illustrated, in some embodiments, the patch 130 is installed also at the second zone 144. In some embodiments (not shown), the patch 130 is installed also at the first zone 142. In some embodiments, the patch 130 includes multiple individual patches 130, such as multiple discrete expandable patches. In some embodiments, the patch 130 is a single patch 130.

The patch 130 includes sealing members 132, such as packers, elastomeric bodies, or the like. The sealing members 132 provide a fluid seal between the patch 130 and the casing string 110. The sealing members 132 hinder fluid communication in the well 100 between the third 146 and fourth 148 zones and the wellhead 150. The sealing members 132 hinder fluid communication in the well 100 between the third 146 and fourth 148 zones and the second 144 and first 142 zones. As illustrated, in embodiments in which the patch 130 is installed at the second zone 144, a sealing member hinders fluid communication in the well 100 between the second zone 144 and the first zone 142. In such embodiments, the patch 130 may include a perforated portion 134 at the second zone to permit fluid flow between the second fracture 54 and the well 100.

The reconfiguring further includes installing a third tubing string 116 in the well 100 after installing the patch 130. The third tubing string 116 extends from the wellhead 150 to a packer 126 within the casing string 110 in the subterranean formation 42. As illustrated, in some embodiments, the packer 126 is set in the patch 130. The packer 126 fluidically separates the first zone 142 of the well 100 from the second zone 144 of the well 100. In the illustrated example, the packer 126 is set in the patch 130 between the perforated portion 134 of the patch 130 and the first zone 142 of the well 100.

FIG. 6 schematically illustrates the well 100 during an exemplary operational phase. Geothermal fluid 12 is produced from the subterranean formation 42 into the well 100 via the first fracture 52, and enters the well at the first zone 142. The geothermal fluid 12 produced into the first zone 142 flows up through the third tubing string 116 to the wellhead 150. Valve 152 at the wellhead 150 controls fluid flow into, and out of, the third tubing string 116. In the illustrated operation, valve 152 is open, and the geothermal fluid 12 flows to the geothermal power system 10, such as through a flowline.

Flow of geothermal fluid 12 from the subterranean formation 42 via the second fracture 54 into the well 100 at the second zone 144 is prevented. The second zone 144 of the well 100 is fluidically coupled with the wellhead 150 via the annulus 117 between the third tubing string 116 and the patch 130, which is fluidically coupled to the annulus 119 between the third tubing string 116 and the casing string 110. Valve 154 at the wellhead 150 controls fluid flow into, and out of, the annulus 119. In the illustrated operation, valve 154 is closed, and geothermal fluid 12 in the annulus 119 and the annulus 117 does not flow out of the wellhead 150. A back-pressure is maintained on the geothermal fluid 12 within the second fracture 54, and geothermal fluid 12 in the subterranean formation 42 does not flow into the second zone 144 of the well 100.

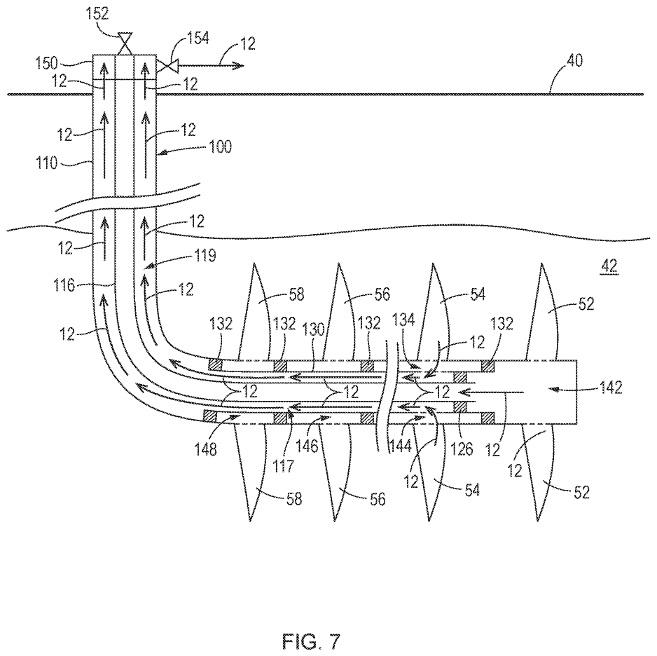

FIG. 7 schematically illustrates another operational phase of the well 100. Valve 152 is closed, ceasing flow of geothermal fluid 12 through the third tubing string 116. A back-pressure is created on the geothermal fluid 12 within the first fracture 52, and geothermal fluid 12 in the subterranean formation 42 ceases to flow into the first zone 142 of the well 100. Valve 154 is opened, relieving the back-pressure on the geothermal fluid 12 in the annulus 119 and the annulus 117. Geothermal fluid 12 is produced from the subterranean formation 42 into the well 100 via the second fracture 54, and enters the well at the second zone 144. The geothermal fluid 12 produced into the second zone 144 flows through the perforated portion 134 of the patch 130, up through the annulus 117, and up through the annulus 119 to the wellhead 150. The open valve 154 permits the geothermal fluid 12 in the annulus 119 to flow to the geothermal power system 10, such as through a flowline.

In some embodiments, the operations depicted in FIGS. 6 and 7 are repeated in an alternating sequence. In an example, valve 154 is closed and valve 152 is opened. The flow of geothermal fluid 12 into the first zone 142 of the well 100 and through the third tubing string 116 is commenced, and is maintained until a trigger condition occurs, such as described above.

When the trigger condition occurs, flow of the geothermal fluid 12 from the subterranean formation 42 into the first zone 142 of the well 100 is ceased by closing the valve 152. Flow of geothermal fluid 12 from the subterranean formation 42 into the second zone 144 of the well 100 is commenced by opening the valve 154. The flow of geothermal fluid 12 into the second zone 144 of the well 100 and through the annulus 117 and annulus 119 is maintained until a corresponding trigger condition occurs (such as described above). Then valve 154 is closed, valve 152 is opened, and the sequence is repeated.

In some embodiments, the well 100 may be reconfigured again to flow geothermal fluid 12 into the well 100 from the subterranean formation 42 via the third fracture 56, the fourth fracture 58, or any other fracture in the subterranean formation 42.

In some embodiments, the well 100 may be used as the second well 46 in conjunction with the geothermal power system 10. In such embodiments, the well 100 as depicted in FIGS. 2 to 7 may be used to inject geothermal fluid 12 into selected fractures 52, 54, 56, or 58 in the subterranean formation 42. The reconfiguring of well 100 when used as the second well 46 may be performed substantially simultaneously with the reconfiguring of the first well 44.

Methods and systems of the present disclosure provide benefits simplicity, cost, and efficiency in managing thermal decline in geothermal resources compared to conventional geothermal wells that intersect many discrete fractured regions of a geothermal reservoir (such as subterranean formation 42). The systems and operations described herein avoid the need to use valves (such as sliding sleeves) downhole in geothermal wells, and provide for reliable operation of geothermal wells.

It is contemplated that operations and methods described herein may include any one or more other non-mutually exclusive operations or methods described herein. It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A method comprising:
producing geothermal fluid from a subterranean formation into a first zone in a well via a first fracture while production of geothermal fluid from the subterranean formation into a second zone in the well is prevented;
ceasing production of geothermal fluid into the first zone;
producing geothermal fluid from the subterranean formation into the second zone via a second fracture while production of geothermal fluid into the first zone is prevented;
closing fluidic access in the well to the first and second zones after producing geothermal fluid into the first and second zones;
opening fluidic access between the subterranean formation and a third zone in the well and between the subterranean formation and a fourth zone in the well while fluidic access in the well to the first and second zones is closed, the opening comprising:
creating a third fracture in the subterranean formation proximal to the third zone; and
creating a fourth fracture in the subterranean formation proximal to the fourth zone;
producing geothermal fluid from the subterranean formation into the third zone via the third fracture while production of geothermal fluid into the first, second, and fourth zones is shut off;
shutting off production of geothermal fluid into the third zone; and
producing geothermal fluid from the subterranean formation into the fourth zone via the fourth fracture while production into the first, second, and third zones in the well is shut off.

2. The method of claim 1, further comprising:
flowing the geothermal fluid produced into the first zone through a first tubing string in the well; and
flowing the geothermal fluid produced into the second zone through an annulus between the first tubing string and a casing string.

3. The method of claim 2, further comprising removing the first tubing string from the well prior to closing fluidic access in the well to the first and second zones

4. The method of claim 3, further comprising installing a second tubing string in the well after opening fluidic access between the subterranean formation and the third and fourth zones.

5. The method of claim 4, further comprising:
flowing the geothermal fluid produced into the third zone through the second tubing string; and
flowing the geothermal fluid produced into the fourth zone through an annulus between the second tubing string and the casing string.

6. The method of claim 1, wherein closing fluidic access in the well to the first and second zones is performed in response to determining a decline in a temperature of the geothermal fluid produced into the first zone or a decline in a temperature of the geothermal fluid produced into the second zone.

7. The method of claim 1, wherein creating the third and fourth fractures comprises pumping a fracturing fluid out of the well into the subterranean formation.

8. A method comprising:
flowing geothermal fluid into a well from a subterranean formation, the flowing comprising alternately flowing the geothermal fluid through a first tubing string in the well and through a first annulus between the first tubing string and a casing string, wherein:
the geothermal fluid flows from the subterranean formation via a first fracture into a first zone of the well, and into the first tubing string; and
the geothermal fluid flows from the subterranean formation via a second fracture into a second zone of the well, and into the first annulus;
closing fluidic access in the well to the first and second zones;
opening fluidic access between the subterranean formation and a third zone in the well and between the subterranean formation and a fourth zone in the well while fluidic access in the well to the first and second zones is closed, the opening comprising:
creating a third fracture in the subterranean formation proximal to the third zone; and
creating a fourth fracture in the subterranean formation proximal to the fourth zone;
recommencing flowing geothermal fluid into the well from the subterranean formation, the flowing comprising alternately flowing the geothermal fluid through a second tubing string in the well and through a second annulus between the second tubing string and the casing string, wherein:
the geothermal fluid flows from the subterranean formation via the third fracture into the third zone of the well, and into the second tubing string; and
the geothermal fluid flows from the subterranean formation via the fourth fracture into the fourth zone of the well, and into the second annulus.

9. The method of claim 8, wherein closing fluidic access in the well to the first and second zones is performed in response to determining a decline in a temperature of the geothermal fluid produced via the first fracture or a decline in a temperature of the geothermal fluid produced via the second fracture.

10. The method of claim 8, wherein closing fluidic access in the well to the first and second zones comprises setting a barrier in the well between a wellhead and the first and second zones.

11. The method of claim 8, further comprising closing fluidic access in the well to the third and fourth zones after determining a decline in a temperature of the geothermal fluid produced into the third zone or a decline in a temperature of the geothermal fluid produced into the fourth zone.

12. The method of claim 11, further comprising reopening fluidic access in the well to the first and second zones after closing fluidic access in the well to the third and fourth zones.

13. The method of claim 19, further comprising recommencing flowing geothermal fluid into the well from the subterranean formation, wherein:
the flowing comprising alternately flowing the geothermal fluid through a third tubing string in the well and through a third annulus between the third tubing string and the casing string;
the geothermal fluid flows from the subterranean formation via the first fracture into the first zone of the well, and into the third tubing string; and
the geothermal fluid flows from the subterranean formation via the second fracture into the second zone of the well, and into the third annulus.

14. A method comprising:
flowing geothermal fluid from a subterranean formation into a first zone of a well via a first fracture in the subterranean formation;
flowing the geothermal fluid produced into the first zone to surface;
shutting off of geothermal fluid into the first zone;
flowing geothermal fluid from the subterranean formation into a second zone of the well via a second fracture in the subterranean formation while flow of geothermal fluid into the first zone is shut off;
flowing the geothermal fluid produced into the second zone to surface;
determining a decline in a temperature of the geothermal fluid flowing from the first fracture or from the second fracture;
closing fluidic access in the well to the first and second zones after determining the decline in the temperature of the geothermal fluid flowing from the first fracture or from the second fracture;
opening fluidic access between the subterranean formation and a third zone in the well and between the subterranean formation and a fourth zone in the well while fluidic access in the well to the first and second zones is closed, the opening comprising:
creating a third fracture in the subterranean formation proximal to the third zone; and
creating a fourth fracture in the subterranean formation proximal to the fourth zone;
flowing geothermal fluid from the subterranean formation into the third zone of the well via the third fracture in the subterranean formation while flow of geothermal fluid into the first, second, and fourth zones is shut off;
shutting off production of geothermal fluid into the third zone; and
flowing geothermal fluid from the subterranean formation into the fourth zone of the well via the fourth fracture in the subterranean formation while flow of geothermal fluid into the first, second, and third zones in the well is shut off.

15. The method of claim 14, wherein:
flowing the geothermal fluid produced into the first zone to surface comprises flowing the geothermal fluid produced into the first zone through a first tubing string in the well; and
flowing the geothermal fluid produced into the second zone to surface comprises flowing the geothermal fluid produced into the second zone through an annulus between the first tubing string and a casing string.

16. The method of claim 15, further comprising:
flowing the geothermal fluid produced into the third zone to surface through a second tubing string in the well; and
flowing the geothermal fluid produced into the fourth zone to surface through an annulus between the second tubing string and the casing string.

17. The method of claim 14, further comprising determining a decline in a temperature of the geothermal fluid produced from the third fracture or the geothermal fluid produced from the fourth fracture.

18. The method of claim 17, further comprising closing fluidic access in the well to the third and fourth zones after determining the decline in the temperature of the geothermal fluid produced from the third fracture or the geothermal fluid produced from the fourth fracture.

19. The method of claim 18, further comprising reopening fluidic access in the well to the first and second zones after closing fluidic access in the well to the third and fourth zones.

20. The method of claim 19, further comprising recommencing flowing geothermal fluid from the subterranean formation into the first zone via the first fracture in the subterranean formation while production of geothermal fluid into the second, third, and fourth zones is shut off.
